(19) United States
(12) Patent Application Publication
(10) Pub. No.: US 2007/0173599 A1
(43) Pub. Date: Jul. 26, 2007

(54) Water-in-oil emulsion composition

(75) Inventors: Ping Liu, Kobe (JP); Jorge Max Sunkel, Cincinnati, OH (US); Toshiya Taniguchi, Kobe (JP); Timothy James Felts, Hamilton, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/657,251

(22) Filed: Jan. 24, 2007

Related U.S. Application Data
(60) Provisional application No. 60/762,040, filed on Jan. 25, 2006.

(51) Int. Cl. C08L 83/04; B01F 3/08; B01F 17/00

(52) U.S. Cl. 524/588; 516/21

(57) ABSTRACT

The present invention is directed to a water-in-oil emulsion composition comprising: (A) an emulsifying silicone elastomer of a particular formula which contains cross-linking and wherein the structure contains a C3-45 alkyl group and a polyoxyalkylene group; (B) an alkyl substituted silicone emulsifier of a particular formula wherein the structure contains a C3-45 organic group and a polyoxyalkylene group; and (C) an aqueous carrier.

### CROSS REFERENCE TO RELATED APPLICATION

This application claims the benefit of U.S. Provisional Application No. 60/762,040 filed on Jan. 25, 2006.

### FIELD OF THE INVENTION

The present invention relates to a water-in-oil emulsion composition comprising an emulsifying silicone elastomer of a certain formulation, an alkyl substituted silicone emulsifier of a certain formulation, and an aqueous carrier. The compositions of the present invention have improved emulsion stability and UV protection benefit, and are particularly useful for foundation products and sunlight protection skin care products.

### BACKGROUND

A foundation composition can be applied to the face and other parts of the body to even skin tone and texture and to hide pores, imperfections, fine lines and the like. A foundation composition is also applied to moisturize the skin, to balance the oil level of the skin, and to provide protection against the adverse effects of sunlight, wind, and other environmental factors.

Foundation and skin care compositions utilizing silicone elastomeric materials and silicone emulsifiers are increasing popularity due to its suitable skin feel. The combination of silicone elastomeric material and silicone emulsifier is also favored from the manufacturer's standpoint, due to its ease of manufacture and stability on the shelf. References which generally disclose such compositions include Japanese patent publications A-2003-286125, A-2002-322030, and A-2000-86438.

Meanwhile, protection from sunlight and UV rays, or in other words high SPF and PA counts, have recently become a function that consumers naturally seek for foundation and skin care products. It is known to one skilled in the art that incorporation of various UV protection agents of different chemical structure provide high UV protection benefit, but that incorporation of such various UV protection agents can also negatively impact the stability of the composition. Balancing of UV protection benefit with composition stability and skin feel upon use is yet challenging.

It is also a recent trend for foundation and skin care products, particularly foundation products, to incorporate various powders for providing color, tone, sebum control, wear, improvement, feel improvement and otherwise, such that many functions of the product can been advertised. It would be highly desirable to have a base composition that could accommodate such various powders having various chemical structures and properties.

Based on the foregoing, there is a need for a water-in-oil composition which provides improved emulsion stability and UV protection benefit. There is also a need, particularly for use as cosmetic foundations, a water-in-oil composition capable of providing improved dispersion of various powders, thereby offering even coverage and long-wear. None of the existing art provides all of the advantages and benefits of the present invention.

### SUMMARY OF THE INVENTION

The present invention is directed to a water-in-oil emulsion composition comprising: (A) an emulsifying silicone elastomer of a particular formula which contains cross-linking and wherein the structure contains a C3-45 alkyl group and a polyoxyalkylene group; (B) an alkyl substituted silicone emulsifier of a particular formula wherein the structure contains a C3-45 organic group and a polyoxyalkylene group; and (C) an aqueous carrier.

By formulating an emulsifying silicone elastomer of a certain formulation and an alkyl substituted silicone emulsifier of a certain formulation, a water-in-oil emulsion of improved emulsion stability and enhanced UV protection benefit is obtained.

These and other features, aspects, and advantages of the present invention will become evident to those skilled in the art from a reading of the present disclosure with the appended claims.

### DETAILED DESCRIPTION OF THE INVENTION

While the specification concludes with claims particularly pointing out and distinctly claiming the invention, it is believed that the present invention will be better understood from the following description.

All percentages, parts and ratios are based upon the total weight of the compositions of the present invention, unless otherwise specified. All such weights as they pertain to listed ingredients are based on the active level and therefore, do not include carriers or by-products that may be included in commercially available materials.

All ingredients such as actives and other ingredients useful herein may be categorized or described by their cosmetic and/or therapeutic benefit or their postulated mode of action. However, it is to be understood that the active and other ingredients useful herein can, in some instances, provide more than one cosmetic and/or therapeutic benefit or operate via more than one mode of action. Therefore, classifications herein are made for the sake of convenience and are not intended to limit an ingredient to the particularly stated application or applications listed.

### Emulsifying Silicone Elastomer

The present composition comprises from about 0.1% to about 10%, preferably from about 0.1% to about 5%, more preferably from about 1% to about 4% of an emulsifying silicone elastomer having the specific chemical structure as detailed below. The emulsifying silicone elastomer of the present invention is a higher alkyl-substituted cross-linked three-dimensional silicone polymer having an elastomeric function coming from the three-dimensional structure, and also an emulsifying function coming from the hydrophobic alkyl group and hydrophilic polyoxyalkylene group in the structure. While the definition “emulsifying silicone elastomer” is used herein to describe the dominating characteristic of the component in comparison with other silicone elastomers as later described, this does not mean the component is devoid of other functions such as gelling upon absorbing solvent.

The emulsifying silicone elastomer of the present invention is represented by the following general formula (1):

R¹ₐR²_{b}R³_{c}SiO_{(4-a-b-c)/2} (1)

wherein; each of R¹, R², and R³ are described below, a is in the range of 1.0-2.5, preferably 1.2-2.3, b is in the range of 0.001-1.5, preferably 0.05-1.0, c is in the range of 0.001-1.5, preferably 0.05-1.0, and the weight average molecular weight of the silicone compound represented by the above formula (1) is in the range of 500-200,000, preferably 1000-100,000; at least one R¹ is an organic group selected from a higher alkyl having 3-45 carbon atoms, preferably 8-30 carbon atoms; and in the case of multiple R¹s, the remaining group is an aryl, aralkyl, fluorine substituted alkyl, amino substituted alkyl or carboxyl substituted alkyl, preferably the remaining R¹ group is propyl, butyl, pentyl hexyl, heptyl, octyl, nonyldecyl, hexadecyl, octadecyl, cyclopentyl, cyclohexyl, phenyl, tolyl, benzyl, phenethyl, trifluoropropyl, heptadecafluorodecyl, 3-aminopropyl, 3-[(2-aminoethyl)amino]propyl, or 3-carboxypropyl;

R² is represented by the following general formula (2);

—CₘH₂ₘ₋—O—(C₂H₄O)_{f}(C₃H₆O)_{g}R⁵ (2)

wherein R⁵ is a hydrogen atom, a hydrocarbon group having 1-30 carbon atoms or an organic group represented by R⁶(CO), and R⁶ is a hydrocarbon group having 1-30 carbon atoms, 0≦m≦15, f and g are integers of 2≦f≦200, preferably 5≦f≦100 and 0≦g≦200, preferably 0≦g≦100 and at the same time, f+g is in the range of 3≦f+g≦200, preferably 5≦f+g≦100, more preferably f/g≧1;

R³ is an organosiloxane represented by the following general formula (3);

—CₙH₂ₙ—(SiR¹₂O)ₕ—SiR¹₃ (3)

wherein R¹ is the same as described above, h is 0≦h≦500, preferably 3≦h≦100, n is an integer of 1≦n≦5, and especially in the case of synthesis by the reaction of vinyl and hydrogen siloxane n is 2.

The emulsifying silicone elastomer of the present invention represented by formula (1) shown above can be synthesized by carrying out an addition reaction of organohydrogenpolysiloxane with a polyoxyalkylene compound via a crosslinking agent having two or more vinyl reactive sites per molecule and to form a crosslinked structure as a result of the reaction with a hydrogen atom directly bonded to the silicon atom, as described in Japanese publication 2003-292415A.

Due to the nature of synthetic reaction by which the emulsifying silicone elastomer is made, the resulting material is a pasty mixture of the emulsifying silicone elastomer absorbing or swelled with a solvent. The solvent can be silicone oil, hydrocarbon oil, or triglyceride oil. Accordingly, the emulsifying silicone elastomer herein is commercially obtainable only in the form of the active elastomers swelled in solvent. The solvent is selected in view of compatibility with the remainder of the composition. Nonetheless, the level of the emulsifying silicone elastomer, as described herein, is based on the weight of the active elastomer, and not on the base of the commercially obtainable material.

It has been surprisingly found that the emulsifying silicone elastomer, when combined with the alkyl-substituted silicone emulsifier hereinafter described, provides a water-in-oil emulsion having improved stability and enhanced UV protection benefit.

Herein, stability of the composition relates to stability of emulsion and stability of color/shade of the composition. Stability of emulsion means absence of phase separation and significant change in viscosity/rheology. Stability of color/shade means absence of significant color and/or lightness change of the composition over time. It is well known in the art that initial color change is observed upon application on any composition due to evaporation of volatile materials, including water, from the skin based on body temperature. Stability of color/shade herein relates to absence of significant change in color and lightness change after such initial color change. Stability of color/shade is an advantageous characteristic for cosmetic products, and particularly so for foundation products.

Herein, UV protection benefit means in-vivo UV protection measured by SPF and PA counts. The present composition provides higher SPF and PA counts as compared to the same composition devoid of the essential emulsifying silicone elastomer herein.

While not wishing to be bound by theory, it is believed that the specific emulsifying silicone elastomer of the present invention provides such stability benefits due to the higher alkyl substitution within the chemical structure, and three-dimensional configuration, as well as the compatibility with the specific alkyl-substituted silicone emulsifier. Also not wishing to be bound by theory, it is believed that the specific emulsifying silicone elastomer provides a suitable rheology such as sufficiently high elastic modulus (G′) in the presence of relatively high levels of organic UV protection agents in the composition, such that the ground energy state of the organic UV protection agents is decreased, and thereby effectiveness is increased.

Commercially available emulsifying silicone elastomers useful herein include such silicone elastomers swelled or gelated in silicone oils, hydrocarbon oils or triglyceride oils, including PEG-15 lauryl dimethicone crosspolymer in mineral oil with tradename KSG-310, PEG-15 lauryl dimethicone crosspolymer in isododecane with tradename KSG-320, PEG-15 lauryl dimethicone crosspolymer in triethylhexanoin with tradename KSG-330, and PEG-10 lauryl dimethicone crosspolymer and PEG-15 lauryl dimethicone crosspolymer in squalane with tradename KSG-340, all available from Shin-Etsu Chemical Co. Ltd.

### Alkyl-Substituted Silicone Emulsifier

The present composition comprises from about 0.5% to about 15%, preferably from about 1% to about 3% of an alkyl-substituted silicone emulsifier having a specific chemical structure of the following general formula (11):

R¹ₐR²_{b}R³_{c}SiO_{(4-a-b-c)/2} (11)

wherein R¹ denotes the same or different organic groups selected from: alkyl groups, aryl groups, aralkyl groups, or fluoride-substituted alkyl groups with 3-45 carbon atoms, preferably 8-30 carbon atoms, wherein not all, but a portion of R¹ can be —CₘH₂ₘ—O—(C₂H₄O)_{d}(C₃H₆O)ₑR⁴;

### R² is a polyoxyalkylene group expressed by —CₘH₂ₘ—O—(C₂H₄O)_{f}(C₃H₆O)_{g}—R⁵;

R³ is (the organosiloxane expressed by) general formula (12) below:

—CₙH₂ₙ—(SiR²R⁴O)ₕ—SiR¹₃ (12)

### R⁴ is a hydrocarbon group with 4-30 carbon atoms or the organic group expressed by R⁶—(CO)—;

R⁵ is a hydrogen atom, a hydrocarbon group with 1-30 carbon atoms, or the organic group expressed by R⁶—(CO)—; R⁶ is a hydrocarbon group with 1-30 carbon atoms. a, b, and c are respectively 1.0≦a≦2.5; 0.001≦b≦1.5; and 0.001≦c≦1.5. d and e are integers, respectively 0≦d≦50 and 0≦e≦50. f and g are respectively 2≦f≦200 and 0≦g≦200, where f+g is an integer from 3-200, m is an integer where 0≦m≦15; h is an integer where 0≦h≦500; and n is an integer where 1≦n≦5.

Preferably, the mass-average molecular weight of the silicone compound expressed by the aforementioned general formula (11), is 500-200,000, more preferably 1000-100,000. The silicone material of formula (11) can be suitably made by the process as described in Japanese publication 2001-39819-A.

Commercially available alkyl-substituted silicone emulsifiers useful herein include lauryl PEG-9 polydimethylsiloxyethyl Dimethicone with tradename and KF6038 available from Shin-Etsu Chemical Co. Ltd.

### Aqueous Carrier

The water-in-oil emulsion compositions of the present invention comprise water in an amount sufficient to provide a discontinuous aqueous phase, typically from about 10% to about 60% of the entire composition. Preferably, water is used for the aqueous carrier. Preferably, water is included in an amount such that the total of volatile silicone oil, if included, and water is more than about 40% of the entire composition. Without being bound by theory, the amount of water herein is believed to provide improved refreshing and light feeling to the skin, without necessarily leaving a dried feeling to the skin. Further, this amount of water allows the inclusion of optional water-soluble skin active agents as described below.

In the present invention, deionized water is typically used. Water from natural sources including mineral cations can also be used, depending on the desired characteristic of the product.

The aqueous carrier of the present invention may comprise a humectant, preferably in an amount from about 1% to about 15%, more preferably from about 2% to about 7%. The humectants herein are selected from the group consisting of polyhydric alcohols, water soluble alkoxylated nonionic polymers, and mixtures thereof. Polyhydric alcohols useful herein include glycerin, propylene glycol, 1,3-butylene glycol, dipropylene glycol, diglycerin, sodium hyaluronate, and mixtures thereof.

Commercially available humectants herein include: glycerin available from Asahi Denka; propylene glycol with tradename LEXOL PG-865/855 available from Inolex, 1,2-PROPYLENE GLYCOL USP available from BASF; 1,3-butylene glycol available from Kyowa Hakko Kogyo; dipropylene glycol with the same tradename available from BASF; diglycerin with tradename DIGLYCEROL available from Solvay GmbH; sodium hyaluronate with tradenames ACTIMOIST available from Active Organics, AVIAN SODIUM HYALURONATE series available from Intergen, HYALURONIC ACID Na available from Ichimaru Pharcos.

### Organic UV Protection Agents

The present composition may further comprise organic UV protection agents for providing sunlight and UV protection benefit. When included, the total of organic UV protection agent is from about 0.5% to about 40%, preferably from about 1% to about 20%, of the entire composition. It has been surprisingly found that the present composition is capable of accommodating a quantity of, as well as variety of, organic UV protection agents, even when UV protection agents of different chemical orientation are combined, while also maintaining good emulsion stability.

In one preferred embodiment, a combination of at least one of oil-soluble organic UV protection agent and at least one water-soluble organic UV protection agents is used. Each of the oil-soluble organic UV protection agent and the water-soluble organic UV protection agents are included at a level of from about 0.1% to about 20%, preferably from about 0.5% to about 10% by weight of the entire composition.

Useful organic UV protection agents include both those which absorb UV radiation mainly in the UVB range, and those which absorb UV radiation mainly in the UVA range. Protection from UVB is described by SPF (Sun Protection Factor) and UVA is described by PA (Protection of UVA). It is well known in the art that combining UVA and UVB protection agents provide a composition having effective sunscreen effect. In one preferred embodiment, the present invention is a sunscreen product or a cosmetic product having an SPF of at least 15 and a PA of at least ++.

Useful oil-soluble organic UV protection agents effective as UVB filters include: 3-benzylidenecamphor derivatives, preferably 3-(4-methylbenzylidene) camphor and 3-benzylidenecamphor; aminobenzoic acid derivatives, preferably 2-ethylhexyl 4-(dimethyl amino)-benzoate and amyl 4-(dimethyl amino)benzoate; esters of cinnamic acid, preferably 2-ethylhexyl 4-methoxycinnamate and isopentyl 4-methoxycinnamate; esters of salicylic acid, preferably 2-thylhexyl salicylate, 4-isopropylbenzyl salicylate and homomenthyl salicylate; derivatives of benzophenone, preferably 2-hydroxy-4-methoxybenzophenone (Benzophenone-3), 2-hydroxy-4-methoxy-4′-methyl benzophenone and 2,2′-dihydroxy-4-methoxybenzophenone; esters of benzalmalonic acid, preferably di(2-ethylhexyl) 4-methoxybenzalmalonate; and 2,4,6-trianilino-(p-carbo-2′-ethyl-1′-hexyloxy)-1,3,5-triazine.

Useful oil-soluble organic UV protection agents effective as UVA filters include: derivatives of dibenzoylmethane, in particular 1-(4′-tert-butylphenyl)-3-(4′-methoxyphenyl) propane-1,3-dione and 1-phenyl-3-(4′-isopropylphenyl)propane-1,3-dione.

Commercially available oil-soluble organic UV protection agents herein include: 2-ethylhexyl 4-methoxycinnamate with tradename PARSOL MCX available from Symrise, and 2-hydroxy-4-methoxybenzophenone (Benzophenone-3) available from BASF.

Useful water-soluble organic UV protection agents effective as UVB filters include: 2-phenylbenzimidazole-5-sulphonic acid, and its sodium, potassium or its triethanol-ammonium salts; sulphonic acid derivatives of benzophenones, preferably 2-hydroxy-4-methoxybenzophenone-5-sulphonic acid (Benzophenone-4) and its salts; sulphonic acid derivatives of 3-benzylidenecamphor, such as, for example 4-(2-oxo-3-bomylidenemethyl)-benzenesulphonic acid, 2-methyl-5-(2-oxo-3-bomylidenemethyl) sulphonic acid and its salts.

Commercially available water-soluble organic UV protection agents herein include: phenylbenzimidazole-5-sulphonic acid with tradename PARSOL HS available from BASF and Neo Helopan Hydro available from Symrise, and 2-hydroxy-4-methoxybenzophenone-5-sulphonic acid (Benzophenone-4) available from BASF.

### Inorganic UV Protection Agents

The present composition may further comprise inorganic UV protection agents. The inorganic UV protection agents herein are distinguished from general powder components later described, as being capable of screening sunlight and UV by having a particle size of smaller than 200 nm, preferably smaller than 100 mm. When included, the level of inorganic UV protection agent is from about 0.1% to about 20%, preferably from about 0.5% to about 10%, of the entire composition.

In one preferred embodiment, a combination of oil-soluble organic UV protection agent and inorganic UV protection agent is used. It has been surprisingly found that, the combined use of organic and inorganic UV protection agents provides a lasting pleasant sensation on the skin by without leaving dryness on the skin. It is generally known that oil-soluble organic UV protection agents tend to leave a greasy sensation on the skin, while inorganic UV protection agents tend to provide dryness of the skin. Without being bound by theory, it is believed that the oil-soluble UV protection agents according to the invention are absorbed by the emulsifying silicone elastomer and the relatively hydrophobic surface of the inorganic UV protection agents, thereby mitigating such negative skin feels.

In another preferred embodiment, the combination of oil-soluble UV protection agent, water-soluble UV protection agent, and inorganic UV protection agent is used for providing high sunscreen effect using as small amount of total UV protection agent as possible. In one preferred embodiment, the present invention is a highly effective sunscreen product having an SPF of at least 35 and a PA of at least +++.

Useful inorganic UV protection agents herein are cosmetic and dermatological acceptable metal oxides and/or other metal compounds which are sparingly soluble or insoluble in water, in particular the oxides of titanium (TiO₂), zinc (ZnO), iron (for example Fe₂O₃), zirconium (ZrO₂), silicon (SiO₂), manganese (for example MnO), aluminum (Al₂O₃) and cerium (for example Ce₂O₃), mixed oxides of the corresponding metals and mixtures of such oxides.

The modifications in which such metal oxides are present are essentially irrelevant to the present invention. For example, TiO₂ occurs in nature in three main modifications (rutile, anatase and brookite), which in principle are all equally suitable. The same applies to the modifications of iron oxides and the like.

Inorganic UV protection agents herein may be given a water-repellent treatment on the surface. This surface treatment can comprise providing the pigments with a thin hydrophobic layer by processes known per se. Such a process may be producing the hydrophobic surface layer by a reaction according to nTiO₂+m(RO)₃Si—R′→nTiO₂ (surf.). n and m here are stoichiometric parameters to be inserted as required, and R and R′ are the desired organic radicals. Hydrophobized pigments prepared analogously to DE-A 33 14 742, for example, are of advantage.

Commercially available inorganic UV protection agents herein include: zinc oxide having an average particle size of about 70 nm with tradename Z-cote HP1 available from BASF, and titanium oxide having an average particle size of about 50 nm with tradenames SI-TTO-S-3Z-LHC and SAMT-UFZO-450 available from Miyoshi.

### Gelling Silicone Elastomer

The present composition may further comprise a gelling silicone elastomer in addition to the essential emulsifying silicone elastomer described hereinabove. The gelling silicone elastomers herein are cross-linked three-dimensional silicone polymers that are not the emulsifying silicone elastomer as described above, but otherwise synthesized in a similar manner, and having similar solvent swelling properties. Compared to the emulsifying silicone elastomer, the gelling silicone elastomers herein may be either lacking the higher alkyl substitution represented by R¹ of general formula (1), or lacking the polyalkoxy substitution represented by R² of general formula (1).

When included, the level of gelling silicone elastomer, on an active basis, is from about 0.01% to about 10%, preferably from about 0.5% to about 6%, of the entire composition. In the preferred cosmetic foundation embodiments of the present invention, gelling silicone elastomers are comprised at from about 0.5% to about 6%, preferably from about 1% to about 4.5%, of the entire composition. Without being bound by theory, it is believed that the gelling silicone elastomers assist in stabilizing the present water-in-oil emulsion.

Commercially available gelling silicone elastomers highly useful herein include those swollen with a solvent such as silicone oil, hydrocarbon oil, or triglyceride oil, including cross-linked polymers with tradenames KSG-15, KSG-16, KSG-41, KSG-42, KSG-43, and KSG-44 all available from Shin-Etsu Chemical Co., Ltd., DC9040 available from Dow Corning, alkyl-modified cross-linked polymers by the tradename of VELVESIL available from General Electrics, and polyether modified cross-linked polymers with tradename KSG-210 available from Shin-Etsu Chemical Co., Ltd.

### Particle Silicone Elastomer

The present composition may further comprise a particle silicone elastomer in addition to the essential emulsifying silicone elastomer described hereinabove. When included, the level of particle silicone elastomer is from about 0.1% to about 30%, preferably from about 0.5% to about 15%, of the entire composition.

The particle silicone elastomer herein can be distinguished from the emulsifying silicone elastomer and gelling silicone elastomer described above, as having an independent and relatively rigid spherical structure. While the particle silicone elastomer is also capable in absorbing certain solvents, it can be easily isolated from the solvent by evaporation or centrifugation. The particle silicone elastomers herein may be silicone rubber spherical particles, polyorganosilsesquioxane resin particles, or silicone rubber spherical particles coated with polyorganosilsesquioxane resin.

The particle silicone elastomers herein provide improved spreadability and transparency to the skin. In one preferred embodiment, a combination of the emulsifying silicone elastomer, gelling silicone elastomer, and particle silicone elastomer is used. The combination of these three types of silicone elastomers provide improved stability to the emulsion of the present composition, as well as improved correction and leveling of unevenness of the skin, such as pores, and thereby providing improved aesthetic benefits such as coverage of defects, while also maintaining good spreadability. The particle silicone elastomers having solvent absorbing properties may also be useful for sebum control.

Commercially available particle silicone elastomers useful herein include KSP-100, KSP-101, KSP-102, KSP-103, KSP-104, KSP-105, KSP-200, and KSP-300 all available from Shin-Etsu Chemical Co., Ltd., hardened polyorgano siloxane elastomers with tradename TREFIL E-506C, tradenames DC9506 and DC9509 available from Dow Corning, polyorganosilsesquioxane resin with tradename TOSPEARL available from GE Toshiba Silicones, and tradename GRANSIL line of elastomers available from Grant Industries.

### Additional Powder

The composition of the present invention may further comprise an additional powder component. The additional powders herein are typically hydrophobic in nature, or hydrophobically treated. The species and levels of the powders other than those described above are selected to provide, for example, shade, coverage, good wear performance, and stability in the composition. Depending on the needs of the product, colorless powders may be selected for providing a colorless foundation, sunscreen, or make up base products.

Additional powders useful herein are clay mineral powders such as talc, mica, sericite, silica, magnesium silicate, synthetic fluorphlogopite, calcium silicate, aluminum silicate, bentonite and montmorillonite; pearl powders such as alumina, barium sulfate, calcium secondary phosphate, calcium carbonate, titanium oxide, zirconium oxide, zinc oxide, hydroxy apatite, iron oxide, iron titanate, ultramarine blue, Prussian blue, chromium oxide, chromium hydroxide, cobalt oxide, cobalt titanate, titanium oxide coated mica; organic powders such as polyester, polyethylene, polystyrene, methyl methacrylate resin, cellulose, 12-nylon, 6-nylon, styrene-acrylic acid copolymers, polypropylene, vinyl chloride polymer, tetrafluoroethylene polymer, boron nitride, fish scale guanine, laked tar color dyes, and laked natural color dyes. Such powders may be treated with a hydrophobical treatment agent, including: silicone such as Methicone, Dimethicone and perfluoroalkylsilane; fatty material such as stearic acid; metal soap such as aluminium dimyristate; aluminium hydrogenated tallow glutamate, hydrogenated lecithin, lauroyl lysine, aluminium salt of perfluoroalkyl phosphate, and mixtures thereof.

Soft focus powders as described in WO 05/082319 are also useful herein. What is meant by soft focus powder is a powder that is particularly effective in providing a soft focus effect to the composition, namely natural finish yet having good coverage for minimizing the appearance of skin troubles, when incorporated in the defined amount. Spherical soft focus powders useful herein include spherical alumina, such as those commercially available with tradename SA-Alumina Beads, available from Miyoshi Kasei Inc., having a Total Luminous Transmittance (Tt) of 62-72, Diffuse Luminous Transmittance (Td) of 45-55, and Haze value {(Td/Tt)×100} of 70-80.

Inorganic and organic oil absorbing powders are useful herein. Inorganic oil absorbing powders include silica, silicate salts, carbonate salts, metal oxides, and hydroxyapatite. Both untreated and surface treated powders can be used, depending on the compatibility with the remainder of the composition. Particularly useful herein are spherical silica powders having an average particle size of from about 1 μm to about 30 μm. Organic oil absorbing powders are useful herein, such as methyl methacrylate copolymers.

Commercially available inorganic oil absorbing powders useful herein include spherical silica with tradename SILDEX H-52 available from Asahi Glass Company Co., Ltd, the same surface treated and with tradename SI SILDEX H-52 available from Miyoshi Kasei, Inc., and spherical silica with tradename GODD BALL SF-16C available from Suzuki Yushi Industrial Co. Ltd., all having an oil absorbency of more than 200 m/100 g. Commercially available powders useful herein include methyl methacrylate copolymer with tradename SA-GMP-0820 available from GANZ Chemical Co., Ltd. surface treated by Miyoshi Kasei, Inc.

Spherical powders other than the soft focus powders and oil absorbing powders may also be used. Unlimited examples of materials useful for making the spherical powders are; polyacrylates, silicates, sulfates, metal dioxides, carbonates, celluloses, polyalkylenes, vinyl acetates, polystyrenes, polyamides, acrylic acid ethers, silicones, and mixtures and complexes thereof. Specifically, materials useful herein include polyacrylates such as nylon, silicates such as calcium silicate, magnesium silicate, barium silicate, aluminium silicate and silica beads; metal dioxides such as titanium dioxide and aluminium hydroxide; carbonates such as calcium carbonate, magnesium carbonate; celluloses; polyalkylenes such as polyethylene, and polypropylene; vinyl acetates; polystyrenes; polyamides; acrylic acid ethers such as acrylic acid methyl ether and acrylic acid ethyl ether; polyvinyl pyrrolidones. Commercially available spherical powders highly useful herein include Nylon-12 with tradename NYLON POWDER series available from Toray.

### Volatile Silicone Oil

The present composition may further comprise a volatile silicone oil. Volatile silicone oil herein may be partly or entirely used for swelling the emulsifying silicone elastomer and optional gelling silicone elastomer described above. Volatile silicone oil is also believed to provide improved refreshing and light feeling to the skin. The amount of volatile silicone is adjusted so that the composition does not necessarily leaving a dried feeling to the skin.

The volatile silicone oil useful herein are selected from linear and cyclic polyalkyl or polyaryl siloxanes those having a boiling point of from about 60 to about 260° C., preferably those having from 2 to 7 silicon atoms.

Commercially available volatile silicone compounds useful herein include octamethyltrisiloxane with tradename SH200C-1 cs, decamethyltetrasiloxane with tradename SH200C-1.5 cs, hexadecamethylheptasiloxane with tradename SH200C-2cs, octamethylcyclotetrasiloxane with tradename SH244, decamethylcyclopentasiloxane with tradename DC245 and SH245, and dodeamethylcyclohexasiloxane with tradename DC246; all available from Dow Corning.

### Non-Volatile Oil

The present composition may further comprise a non-volatile oil. When incorporated, preferably, the amount is from about 0.5% to about 20%. Without being bound by theory, the species and levels of the non-volatile oil herein is believed to provide improved smoothness to the skin, and also alleviate dry feeling of the skin.

Non-volatile oils useful herein are, for example, isotridecyl isononanoate, isostearyl isostearate, isocetyl isosteatrate, isopropyl isostearate, isodecyl isononanoate, cetyl octanoate, isononyl isononanoate, diisopropyl myristate, isocetyl myristate, isotridecyl myristate, isopropyl myristate, isostearyl palmitate, isocetyl palmitate, isodecyl palmitate, isopropyl palmitate, octyl palmitate, caprylic/capric acid triglyceride, glyceryl tri-2-ethylhexanoate, neopentyl glycol di(2-ethyl hexanoate), diisopropyl dimerate, tocopherol, tocopherol acetate, avocado oil, camellia oil, turtle oil, macadamia nut oil, corn oil, mink oil, olive oil, rapeseed oil, eggyolk oil, sesame oil, persic oil, wheat germ oil, pasanqua oil, castor oil, linseed oil, safflower oil, cotton seed oil, perillic oil, soybean oil, peanut oil, tea seed oil, kaya oil, rice bran oil, china paulownia oil, Japanese paulownia oil, jojoba oil, rice germ oil, glycerol trioctanate, glycerol triisopalmiatate, trimethylolpropane triisostearate, isopropyl myristate, glycerol tri-2-ethylhexanoate, pentaerythritol tetra-2-ethylhexanoate, lanolin, liquid lanolin, liquid paraffin, squalane, vaseline, and mixtures thereof. Commercially available oils include, for example, isotridecyl isononanoate with tradename Crodamol TN available from Croda, Hexalan available from Nisshin Seiyu, and tocopherol acetates available from Eisai.

In one preferred embodiment, isotridecyl isononanoate is used as a solvent for the oil-soluble organic UV protection agents, such as 2-hydroxy-4-methoxybenzophenone (Benzophenone-3) as described above. It has been surprisingly found that isotridecyl isononanoate is effective in maintaining the stability of such UV protection agents in combination with the other essential components of the present invention, and prevent them from crystallizing. Crystallization of organic UV protection agents may cause undesirable irritation to the skin, and thus is preferably avoided.

Non-volatile oils useful herein also include linear polyalkyl or polyaryl siloxanes having from about 7 to about 8,000 repeating units. These silicone compounds are available, for example, from the General Electric Company in their Viscasil® and SF 96 series, and from Dow Corning in their Dow Corning 200 series, polymethylphenylsiloxanes available from the General Electric Company as SF 1075 methyl phenyl fluid or from Dow Corning as 556 Cosmetic Grade Fluid.

Non-volatile oils also useful herein are the various grades of mineral oils. Mineral oils are liquid mixtures of hydrocarbons that are obtained from petroleum. Specific examples of suitable hydrocarbons include paraffin oil, mineral oil, dodecane, isododecane, hexadecane, isohexadecane, eicosene, isoeicosene, tridecane, tetradecane, polybutene, polyisobutene, and mixtures thereof.

### Additional Lipophilic Surfactant

The composition of the present invention may further comprise an additional lipophilic surfactant in addition to the essential alkyl-substituted silicone emulsifier. When incorporated, the amount included is preferably from about 0.1% to about 10%. Without being bound by theory, the species and levels of the lipophilic surfactant herein are believed to provide a stable water-in-oil emulsion in view of the other components of the present invention. The lipophilic surfactant herein has an HLB value of less than about 8. According to the components included in the present composition, a mixture of at least one ester-type surfactant and at least one silicone-type surfactant to provide a stable emulsion for the other essential components of the present invention.

Commercially available ester-type surfactants are, for example, sorbitan isostearate having a tradename Crill 6 available from Croda, and sorbitan sesquioleate with tradename Arlacel 83 available from Kao Atras.

Commercially available silicone-type surfactants are, for example, dimethicone copolyols DC5225C, BY22-012, BY22-008, SH3746M, SH3771M, SH3772M, SH3773M, SH3775M, SH3748, SH3749, and DC5200, all available from Dow Corning, and cetyl dimethicone copolyol, also called Methylpolysiloxane Cetylmethylpolysiloxane Poly(oxyethylene oxypropylene) Methylpolysiloxane Copolymer, having an HLB of about 5 and a molecular weight of about 13,000 having a tradename ABIL EM90 available from Goldschmidt Personal Care, and PEG-9 polydimethylsiloxyethyl Dimethicone with tradename KF-6028 available from ShinEtsu Chemical Co., Ltd.

### Skin Active Agent

The compositions of the present invention may comprise a safe and effective amount of a skin active agent. The term “skin active agent” as used herein, means an active ingredient which provides a cosmetic and/or therapeutic effect to the area of application on the skin, hair, or nails. The skin active agents useful herein include skin lightening agents, anti-acne agents, emollients, non-steroidal anti-inflammatory agents, topical anaesthetics, artificial tanning agents, antiseptics, anti-microbial and anti-fungal actives, skin soothing agents, sunscreening agents, skin barrier repair agents, anti-wrinkle agents, anti-skin atrophy actives, lipids, sebum inhibitors, sebum inhibitors, skin sensates, protease inhibitors, skin tightening agents, anti-itch agents, hair growth inhibitors, desquamation enzyme enhancers, anti-glycation agents, and mixtures thereof. When included, the present composition comprises from about 0.001% to about 30%, preferably from about 0.001% to about 10% of at least one skin active agent.

The type and amount of skin active agents are selected so that the inclusion of a specific agent does not affect the stability of the composition.

Skin lightening agents useful herein refer to active ingredients that improve hyperpigmentation as compared to pre-treatment. Useful skin lightening agents herein include ascorbic acid compounds, vitamin B₃ compounds, azelaic acid, butyl hydroxyanisole, gallic acid and its derivatives, glycyrrhizinic acid, hydroquinone, kojic acid, arbutin, mulberry extract, and mixtures thereof. Use of combinations of skin lightening agents is believed to be advantageous in that they may provide skin lightening benefit through different mechanisms.

Ascorbic acid compounds useful herein include, ascorbic acid per se in the L-form, ascorbic acid salt, and derivatives thereof. Ascorbic acid salts useful herein include, sodium, potassium, lithium, calcium, magnesium, barium, ammonium and protamine salts. Ascorbic acid derivatives useful herein include, for example, esters of ascorbic acid, and ester salts of ascorbic acid. Particularly preferred ascorbic acid compounds include 2-o-D-glucopyranosyl-L-ascorbic acid, which is an ester of ascorbic acid and glucose and usually referred to as L-ascorbic acid 2-glucoside or ascorbyl glucoside, and its metal salts, and L-ascorbic acid phosphate ester salts such as sodium ascorbyl phosphate, potassium ascorbyl phosphate, magnesium ascorbyl phosphate, and calcium ascorbyl phosphate. Commercially available ascorbic compounds include magnesium ascorbyl phosphate available from Showa Denko, 2-o-D-glucopyranosyl-L-ascorbic acid available from Hayashibara and sodium L-ascorbyl phosphate with tradename STAY C available from Roche.

Vitamin B₃ compounds useful herein include, for example, those having the formula:

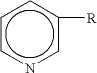

wherein R is —CONH₂ (e.g., niacinamide) or —CH₂OH (e.g., nicotinyl alcohol); derivatives thereof; and salts thereof. Exemplary derivatives of the foregoing vitamin B₃ compounds include nicotinic acid esters, including non-vasodilating esters of nicotinic acid, nicotinyl amino acids, nicotinyl alcohol esters of carboxylic acids, nicotinic acid N-oxide and niacinamide N-oxide. Preferred vitamin B₃ compounds are niacinamide and tocopherol nicotinate, and more preferred is niacinamide. In a preferred embodiment, the vitamin B₃ compound contains a limited amount of the salt form and is more preferably substantially free of salts of a vitamin B₃ compound. Preferably the vitamin B₃ compound contains less than about 50% of such salt, and is more preferably essentially free of the salt form. Commercially available vitamin B₃ compounds that are highly useful herein include niacinamide USP available from Reilly.

Other hydrophobic skin lightening agents useful herein include ascorbic acid derivatives such as ascorbyl tetraisopalmitate (for example, VC-IP available from Nikko Chemical), ascorbyl palmitate (for example available from Roche Vitamins), ascorbyl dipalmitate (for example, NIKKOL CP available from Nikko Chemical); undecylenoyl phenyl alanine (for example, SEPIWHITE MSH available from Seppic); octadecenedioic acid (for example, ARLATONE DIOIC DCA available from Uniquema); oenothera biennis sead extract, and pyrus malus (apple) fruit extract, and mixtures thereof.

Other skin active agents useful herein include those selected from the group consisting of panthenol, tocopheryl nicotinate, benzoyl peroxide, 3-hydroxy benzoic acid, flavonoids (e.g., glycosyl hesperidine, flavanone, chalcone), famesol, phytantriol, glycolic acid, lactic acid, 4-hydroxy benzoic acid, acetyl salicylic acid, 2-hydroxybutanoic acid, 2-hydroxypentanoic acid, 2-hydroxyhexanoic acid, cis-retinoic acid, trans-retinoic acid, retinol, retinyl esters (e.g., retinyl propionate), phytic acid, N-acetyl-L-cysteine, lipoic acid, tocopherol and its esters (e.g., tocopheryl acetate), azelaic acid, arachidonic acid, tetracycline, ibuprofen, naproxen, ketoprofen, hydrocortisone, acetominophen, resorcinol, phenoxyethanol, phenoxypropanol, phenoxyisopropanol, 2,4,4′-trichloro-2′-hydroxy diphenyl ether, 3,4,4′-trichlorocarbanilide, octopirox, lidocaine hydrochloride, clotrimazole, miconazole, ketoconazole, neomycin sulfate, theophylline, and mixtures thereof.

### Additional Components

The compositions hereof may further contain additional components such as are conventionally used in topical products, e.g., for providing aesthetic or functional benefit to the composition or skin, such as sensory benefits relating to appearance, smell, or feel, therapeutic benefits, or prophylactic benefits (it is to be understood that the above-described required materials may themselves provide such benefits).

Examples of suitable topical ingredient classes include: anti-cellulite agents, antioxidants, radical scavengers, chelating agents, vitamins and derivatives thereof, abrasives, other oil absorbents, astringents, dyes, essential oils, fragrance, structuring agents, film forming polymers, solubilizing agents, anti-caking agents, antifoaming agents, binders, buffering agents, bulking agents, denaturants, pH adjusters, propellants, reducing agents, sequestrants, cosmetic biocides, alcohols and preservatives.

### EXAMPLES

The following examples further describe and demonstrate the preferred embodiments within the scope of the present invention. The examples are given solely for the purpose of illustration, and are not to be construed as limitations of the present invention since many variations thereof are possible without departing from its spirit and scope.

The following water-in-oil emulsion compositions are formed by the process described herein:

Composition for Examples 1–6

| | Components | Ex. 1 | Ex. 2 | Ex. 3 | Ex. 4 | Ex. 5 | Ex. 6 |
|---|---|---|---|---|---|---|---|
| A | Isotridecyl Isononanoate *1 | 6 | 6 | 6 | 6 | 6 | 6 |
| A | Decamethylcyclopentasiloxane *2 | 7.2 | 4.2 | 1.2 | 0.7 | 2.8 | 25.6 |
| A | Lauryl PEG-9 Polydimethyl-siloxyethyl | 0.5 | 5 | 2 | 1.5 | 1.5 | 1.5 |
| | Dimethicone *3 | | | | | | |
| A | Slurry of Iron Oxide, Cyclopentasiloxane, | | 2 | 2 | 2 | 0.5 | 2 |
| | Dimethicone and Disodium Hydrogenated | | | | | | |
| | Glutamate *4 | | | | | | |
| A | Mixture of ascorbyl tetraisopalmitate, silica, | | | 1 | 1 | 1 | 0.1 |
| | and dimethicone *5 | | | | | | |
| A | Powder Mix *6 | | | 0.5 | 0.5 | 0.5 | 0.1 |
| A | Mixture of mica, titanium dioxide, silica, iron | | | 0.5 | 0.5 | 0.5 | 0.1 |
| | oxide, alumina, and dimethicone/methicone | | | | | | |
| | copolymer *7 | | | | | | |
| A | 2-ethylhexyl 4-methoxycinnamate *8 | 3 | 3.5 | 3.5 | 3 | 3 | 3 |
| A | 2-Hydroxy-4-methoxybenzophenone | | | | 0.5 | 0.5 | 0.5 |
| | (Benzophenone-3) *9 | | | | | | |
| A | Titanium Dioxide and Methicone *10 | 11.6 | 11.6 | 11.6 | 11.6 | | 11.6 |
| A | Titanium Dioxide, Dimethicone, Aluminium | | | | | 2 | |
| | Hydroxide and Stearic Acid *11 | | | | | | |
| A | Cyclopentasiloxane (87.4%) and Dimethicone | 0.5 | 22.5 | 20 | 20 | 30 | 5 |
| | Crosspolymer (12.6%) Blend *12 | | | | | | |
| A | Isododecane (75%) and PEG-15/Lauryl | 29 | 1.5 | 5 | 8 | 8 | 1 |
| | Dimethicone Crosspolymer (25%) Blend *13 | | | | | | |
| A | Vinyl Dimethicone/Methicone Silesquioxane | | 1 | 4 | 2 | 1 | 0.5 |
| | Crosspolymer *14 | | | | | | |
| B | Water | 28.6 | 28.6 | 28.6 | 28.6 | 21.6 | 25 |
| B | Preservatives | 0.7 | 0.7 | 0.7 | 0.7 | 0.7 | 0.7 |
| B | Phenylbenzimidazole Sulfonic Acid *15 | 3 | 3.5 | 3.5 | 3 | 3 | 3 |
| B | 2-Hydroxy-4-methoxybenzophenone-5- | | | | 0.5 | 0.5 | 0.5 |
| | Sulfonic Acid (Benzophenone-4) *16 | | | | | | |
| B | Butylene Glycol *17 | 7.4 | 7.4 | 7.4 | 7.4 | | 7.4 |
| B | Glycerin *18 | | | | | 7.4 | |
| B | Niacinamide *19 | | | | | 2 | |
| B | Mixture of Saccharomycopsis Ferment Filtrate | | | | | 5 | |
| | and Butylene Glycol and Methylparaben *20 | | | | | | |
| B | Triethanolamine *21 | 2.5 | 2.5 | 2.5 | 2.5 | 2.5 | 2.5 |
| C | Candelilla Wax *22 | | | | | | 2 |
| C | Ceresin *23 | | | | | | 1.9 |

Compositions for Examples 7–12

| | | | | | Ex. | Ex. | Ex. |
|---|---|---|---|---|---|---|---|
| | Components | Ex. 7 | Ex. 8 | Ex. 9 | 10 | 11 | 12 |
| A | Isotridecyl Isononanoate *1 | 6 | 6 | 2 | 6 | 6 | 6 |
| A | Decamethylcyclopentasiloxane *2 | 15.8 | 5.2 | 0.7 | 19.7 | 8.3 | 35.4 |
| A | Lauryl PEG-9 Polydimethyl-siloxyethyl | 0.5 | 2 | 4 | 1 | 1 | 1 |
| | Dimethicone *3 | | | | | | |
| A | Slurry of Iron Oxide, Cyclopentasiloxane, | | | 0.5 | | | 0.5 |
| | Dimethicone and Disodium Hydrogenated | | | | | | |
| | Glutamate *4 | | | | | | |
| A | Mixture of ascorbyl tetraisopalmitate, silica, | | | | | 1 | 1 |
| | and dimethicone *5 | | | | | | |
| A | Powder Mix *6 | | | | | 0.5 | 0.5 |
| A | Mixture of mica, titanium dioxide, silica, iron | | | | | 0.5 | 0.5 |
| | oxide, alumina, and dimethicone/methicone | | | | | | |
| | copolymer *7 | | | | | | |
| A | 2-ethylhexyl 4-methoxycinnamate *8 | 3.5 | 3 | 6 | | | 3 |
| A | 2-Hydroxy-4-methoxybenzophenone | — | 1 | 0.5 | | | 0.5 |
| | (Benzophenone-3) *9 | | | | | | |
| A | Titanium Dioxide and Methicone *10 | 2 | 11.6 | 11.6 | 0.6 | | 0.6 |
| A | Titanium Dioxide, Dimethicone, Aluminium | | | 1.5 | | | |
| | Hydroxide and Stearic Acid *11 | | | | | | |
| A | Zinc Oxide and Dimethicone *24 | | | 1.5 | | | |
| A | Cyclopentasiloxane (87.4%) and Dimethicone | 20 | 20 | 20 | 20 | 30 | |
| | Crosspolymer (12.6%) Blend *12 | | | | | | |
| A | Dimethicone (76%) and Vinyl Dimethicone | | | | | | 5 |
| | Crosspolymer (24%) Blend *25 | | | | | | |
| A | Isododecane (75%) and PEG-15/Lauryl | 8 | 7 | 5 | 8 | | 1 |
| | Dimethicone Crosspolymer (25%) Blend *13 | | | | | | |
| A | Dimethicone PEG-10/15 Crosspolymer (24%) | | | | | 8 | |
| | and Dimethicone (75%) Blend *26 | | | | | | |
| A | Vinyl Dimethicone/Methicone Silesquioxane | 1.5 | 1 | 4 | 2 | 2 | 0.5 |
| | Crosspolymer *14 | | | | | | |
| B | Water | 26.6 | 26.6 | 15.6 | 34.6 | 27.6 | 32.9 |
| B | Preservatives | 0.7 | 0.7 | 0.7 | 0.7 | 0.7 | 0.7 |
| B | Phenylbenzimidazole Sulfonic Acid *15 | 3.5 | 3 | 6 | | | 3 |
| B | 2-Hydroxy-4-methoxybenzophenone-5- | | 1 | 1 | | | 0.5 |
| | Sulfonic Acid (Benzophenone-4) *16 | | | | | | |
| B | Butylene Glycol *17 | | | 7.4 | 7.4 | | |
| B | Glycerin *18 | 7.4 | 7.4 | | | 7.4 | 7.4 |
| B | Niacinamide *19 | 2 | 2 | 2 | | 2 | |
| B | Mixture of Saccharomycopsis Ferment Filtrate | | | 5 | | 5 | |
| | and Butylene Glycol and Methylparaben *20 | | | | | | |
| B | Triethanolamine *21 | 2.5 | 2.5 | 5 | | | |

Definitions of Components
*1 Isotridecyl Isononanoate: Crodamol TN available from Croda
*2 Decamethylcyclopentasiloxane: SH245 available from Dow Corning
*3 Lauryl PEG-9 Polydimethyl-siloxyethyl Dimethicone: KF6038 available from Shinetsu Chemical Co., Ltd.
*4 Slurry of Iron Oxide, Cyclopentasiloxane, Dimethicone and Disodium Hydrogenated Glutamate: SA/NAI-Y-10/D5 (70%), SA/NAI-R-10/D5 (65%) and SA/NAI-B-10/D5 (75%) available from Miyoshi Kasei
*5 Mixture of ascorbyl tetraisopalmitate, silica, and dimethicone: SA-SB-705/VC-IP available from Miyoshi Kasei
*6 Powder Mix: Mixture of Methyl Methacrylate Crosspolymerand Sodium Cocoyl Glycinate and Calcium Hydroxide and Iron Oxides with tradename Grandeur Pearl Powder Pink available from Miyoshi Kasei
*7 Mixture of mica, titanium dioxide, silica, iron oxide, alumina, and dimethicone/methicone copolymer: Relief Color Pink P-2 available from Nihon Shokubai
*8 2-ethylhexyl 4-methoxycinnamate: PARSOL MCX available from Symrise
*9 2-Hydroxy-4-methoxybenzophenone (Benzophenone-3): available from BASF
*10 Titanium Dioxide and Methicone: SI-T-CR-50-Z (80%) LHC available from Miyoshi Kasei
*11 Titanium Dioxide, Dimethicone, Aluminum Hydroxide and Stearic Acid: SAST-UFTR-Z available from Miyoshi Kasei
*12 Cyclopentasiloxane (87.4%) and Dimethicone Crosspolymer (12.6%) Blend: DC-9040 available from Dow Corning
*13 Isododecane (75%) and PEG-15/Lauryl Dimethicone Crosspolymer (25%) Blend: KSG-320 available from Shinetsu Silicone
*14 Vinyl Dimethicone/Methicone Silesquioxane Crosspolymer: KSP-100 available from Shinetsu Silicone
*15 Phenylbenzimidazole Sulfonic Acid: Neo Haliopan Hydro available from Symrise
*16 2-Hydroxy-4-methoxybenzophenone-5-Sulfonic Acid: Benzophenone-4 available from BASF
*17 Butylene Glycol: 1,3 Butylene Glycol available from Kyowa Hakko Kogyo
*18 Glycerin: Glycerin USP available from Asahi Denka
*19 Niacinamide: Niacinamide available from Reilly Industries Inc.
*20 Mixture of Saccharomycopsis Ferment Filtrate and Butylene Glycol and Methylparaben: SK-2 4X available from P&G
*21 Triethanolamine: TEA available from Dow Chemical
*22 Candelilla Wax: Candelilla wax NC-1630 available from Cerarica Noda
*23 Ceresin: Ozokerite wax SP-1021 available from Strahl & Pitsh
*24 Zinc Oxide and Dimethicone: Z-Cote HP1 available from BASF
*25 Dimethicone (76%) and Vinyl Dimethicone Crosspolymer (24%) Blend: KSG-15 available from Shin-Etsu Chemical Co., Ltd.
*26 Dimethicone PEG-10/15 Crosspolymer (24%) and Dimethicone (75%) Blend: KSG-210 available from Shin-Etsu Chemical Co., Ltd.

### Method of Preparation

The compositions of Examples 1-12 excluding Example 6 are prepared as follows:

### 1) Components of Phase A are mixed with suitable mixer until homogeneous to make a lipophilic mixture.

2) Components of Phase B are dissolved with suitable mixer until all components are completely dissolved to make a water phase. The water phase is added into the product of step 1) to make emulsion at room temperature using homogenizer. The composition of Example 6 is prepared by taking steps 1) and 2) above, and further:
3) Components of phase C are heated to dissolve at 80-85° C. in a sealed tank. The melted waxes are added into the product of step 2) using homogenizer.

### 4) Finally, the obtained emulsion is filled in an air-tight container and allowed to cool to room temperature using a cooling unit.

The embodiments represented by the previous examples have many advantages when applied to the skin as make up or skin care compositions. Examples 1-4 are useful as liquid foundation products having an SPF of 15-35, and a PA of ++. Examples 1 and 4 meet global criteria of dosage limit for UV protection agents. Examples 1-4 further have improved even coverage, improved transparent look, sebum control, and long-wear. Example 5 is useful as a make up base product. Example 5, when applied to the skin prior to applying a foundation, provides color stability of the foundation applied on top, improved even coverage, improved transparent look, sebum control, and long-wear. Example 6 is useful as a solid foundation product having an SPF of 15-35, and a PA of ++, which meets global criteria of dosage limit for UV protection agents. Examples 7-9 are useful as sunscreen products. Examples 7 and 8 have an SPF in the range of 15 to 35, and a PA of ++, and Example 9 has an SPF of over 35 and PA of +++. Examples 10-12 are useful as skincare cream products having an SPF in the range of 12 to 17, and a PA of +. All embodiments have improved emulsion stability and improved spreadability and reduced sticky feel while also being moisturizing to the skin.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-in-oil emulsion composition comprising:
(A) an emulsifying silicone elastomer of the following formula (1):
R¹ₐR²_{b}R³_{c}SiO_{(4-a-b-c)/2} (1)
wherein; each of R¹, R², and R³ are described below, a is in the range of 1.0-2.5, b is in the range of 0.001-1.5, c is in the range of 0.001-1.5, and the weight average molecular weight of the silicone compound represented by the above formula (1) is in the range of 500-200,000;
at least one R¹ is an organic group selected from a higher alkyl having 3-45 carbon atoms, and in the case of multiple R¹s, the remaining group is an aryl, aralkyl, fluorine substituted alkyl, amino substituted alkyl or carboxyl substituted alkyl,
R² is represented by the following general formula (2);
—CₘH₂ₘ₋—O—(C₂H₄O)_{f}(C₃H₆O)_{g}R⁵ (2)
wherein R⁵ is a hydrogen atom, a hydrocarbon group having 1-30 carbon atoms or an organic group represented by R⁶(CO), and R⁶ is a hydrocarbon group having 1-30 carbon atoms, 0≦m≦15, f and g are integers of 2≦f≦200, and at the same time, f+g is in the range of 3≦f+g≦200;
R³ is an organosiloxane represented by the following general formula (3);
—CₙH₂ₙ—(SiR¹₂O)ₕ—SiR¹₃ (3)
wherein R¹ is the same as described above, h is 0≦h≦500, n is an integer of 1≦n≦5;
(B) an alkyl substituted silicone emulsifier of the following formula (11):
R¹ₐR²_{b}R³_{c}SiO_{(4-a-b-c)}₂ (11)
wherein R¹ denotes the same or different organic groups selected from: alkyl groups, aryl groups, aralkyl groups, or fluoride-substituted alkyl groups with 3-30 carbon atoms, wherein not all, but a portion of R¹ can be —CₘH₂ₘ—O—(C₂H₄O)_{d}(C₃H₆O)ₑR⁴;
R² is a polyoxyalkylene group expressed by —CₘH₂ₘ—O—(C₂H₄O)_{f}(C₃H₆O)_{g}—R⁵;
R³ is (the organosiloxane expressed by) general formula (12) below:
—CₙH₂ₙ—(SiR²R⁴O)ₕ—SiR¹₃ (12)
R⁴ is a hydrocarbon group with 4-30 carbon atoms or the organic group expressed by R⁶—(CO)—;
R⁵ is a hydrogen atom, a hydrocarbon group with 1-30 carbon atoms, or the organic group expressed by R⁶—(CO)—; R⁶ is a hydrocarbon group with 1-30 carbon atoms. a, b, and c are respectively 1.0≦a≦2.5; 0.001≦b≦1.5; and 0.001≦c≦1.5. d and e are integers, respectively 0≦d≦50 and 0≦e≦50. f and g are respectively 2≦f≦200 and 0≦g≦200, where f+g is an integer from 3-200, m is an integer where 0≦m≦15; h is an integer where 0≦h≦500; and n is an integer where 1≦n≦5; and
(C) an aqueous carrier.

2. The composition of claim, 1 further comprising a UV protection agent selected from organic UV protection agents and inorganic UV protection agents.

3. The composition of claim 2, comprising an oil-soluble organic UV protection agent and a water-soluble organic UV protection agent.

4. The composition of claim 2, comprising an oil-soluble organic UV protection agent and an inorganic UV protection agent.

5. The composition of claim 3, further comprising isotridecyl isononanoate.

6. The composition of claim 4, further comprising isotridecyl isononanoate

7. The composition of claim 1, further comprising a gelling silicone elastomer.

8. The composition of claim 1, further comprising a particle silicone elastomer.

9. The composition of claim 6, further comprising a particle silicone elastomer.

10. A method of correcting skin defects, comprising a step of applying to the skin the composition of claim 7.

11. A method of leveling skin unevenness, comprising a step of applying to the skin the composition of claim 7.
